(19) United States
(12) Patent Application Publication
(10) Pub. No.: US 2014/0160404 A1
(43) Pub. Date: Jun. 12, 2014

(54) DISPLAY DEVICE FOR OUTDOOR USE

(71) Applicant: FUJIFILM CORPORATION, Tokyo (JP)

(72) Inventors: Naoyoshi YAMADA, Kanagawa (JP); Yu NAITO, Kanagawa (JP); Nobutaka FUKAGAWA, Kanagawa (JP); Aiko YOSHIDA, Kanagawa (JP); Yukie WATANABE, Kanagawa (JP)

(73) Assignee: FUJIFILM CORPORATION, Tokyo (JP)

(21) Appl. No.: 14/101,694

(22) Filed: Dec. 10, 2013

(30) Foreign Application Priority Data
Dec. 11, 2012 (JP) 2012-270502

(51) Int. Cl. G02B 5/20; G02F 1/1335

(52) U.S. Cl. CPC G02B 5/208; G02F 1/133528
USPC 349/96; 359/352; 362/19

(57) ABSTRACT

A display device for outdoor use has a display unit, and the display unit includes a polarizing plate having a light absorbing layer and a polarizer layer on a viewing side surface, the light absorbing layer includes a first light absorbing agent having at least one absorption peak in a wavelength range of from 280 to less than 360 nm and a second light absorbing agent having at least one absorption peak in a wavelength range of from 360 to 400 nm, and the light absorbing layer is disposed closer to the viewing side than the polarizer layer.

### CROSS-REFERENCE TO RELATED APPLICATIONS

This application claims the benefit of Japanese Patent Application JP 2012-270502, filed Dec. 11, 2012, the entire content of which is hereby incorporated by reference, the same as if set forth at length.

### FIELD OF THE INVENTION

The present invention relates to a display device for outdoor use using a polarizing plate or circularly polarizing plate.

### BACKGROUND OF THE INVENTION

In recent years, a display device for outdoor use has been used as an advertising medium (digital signage) displaying an image or information outdoors (see, for example, JP-A-2006-163217 (the term “JP-A” as used herein means an “unexamined published Japanese patent application”)).

However, when such a display device is used outdoors, a problem occurs in that a polarizer included in the display device is deteriorated by exposure to light (particularly, sunlight) to result in significant reduction of the display quality.

In order to solve the problem, for example, a method for increasing light fastness by using a crystalline polarizer is disclosed, for example, in JP-T-2007-534971 (the term “JP-T” as used herein means a published Japanese translation of a PCT patent application). However, since the crystalline polarizer is ordinarily expensive and the crystalline polarizer having a large area is difficult to be produced, it is not adequate to a display device having a large screen.

In JP-A-2006-163217, a method where a liquid crystal display device is placed in a chassis and a transparent plate composed of a polycarbonate or the like is disposed outside the liquid crystal panel is disclosed. However, in JP-A-2006-163217, only common ultraviolet ray shielding is considered and the method is insufficient to protect the display device from sunlight. Further, the luminance method has a problem in that light reflection occurs between the transparent plate and the liquid crystal panel to cause reduction of visibility. It is necessary to increase luminance of backlight in order to improve the visibility, but it results in increase in power consumption and increase in heat generation to cause a problem in that deterioration of the device is more accelerated.

A polarizing plate or circularly polarizing plate for use in a common liquid crystal display device or organic EL display device is a stack in which a protective film composed of a cellulose acylate or the like and a retardation film are stuck on both surfaces of a polarizer prepared by adsorbing iodine to polyvinyl alcohol (PVA). In such a case, a method of using a protective film containing an ultraviolet absorbing agent in order to protect the polarizer and liquid crystal panel from an ultraviolet ray is well known.

In JP-A-2006-282979, a cellulose acylate film containing a compound having a structure of benzotriazole, triazine, benzophenone or cyanoacrylate, as an ultraviolet absorbing agent is disclosed.

In JP-A-2002-350644, a cellulose acylate film containing a compound having a structure of benzotriazole having at least one secondary alkyl group in a phenol moiety, as an ultraviolet absorbing agent is disclosed.

Also, in JP-A-2002-53824, JP-A-2002-80788, JP-A-2002-150827, JP-A-2003-112391, JP-A-2005-189645 and JP-A-2008-195830, a method of producing a film wherein a problem of yellowish coloration is solved by incorporating a fluorescent brightening agent.

### SUMMARY OF THE INVENTION

In general, in display devices for indoor use, there is a case of using a protective film absorbing an ultraviolet ray having a wavelength range of less than 380 nm is employed as a protective film for polarizing plate, and it is believed that such a display device is required to more increase the absorption in the wavelength range when used outdoors. Any method described in JP-A-2006-282979 and JP-A-2002-350644 has been invented with the intention to effectively absorb an ultraviolet ray having a wavelength range of less than 380 nm.

In order to more increase the absorption in a wavelength range of less than 380 nm, a method of increasing an addition amount of an ultraviolet absorbing agent having an absorption peak of less than 360 nm is known, but in such a case when a thickness of film is reduced, a problem arises in that whitening or bleed out is apt to occur.

In order to prevent the occurrence of whitening or bleed out even when the addition amount of ultraviolet absorbing agent increases, it is necessary to increase the thickness of film, thereby causing a problem of increasing a thickness of polarizing plate or display device, which is against requirement in the market.

As a result of intensive investigations, the inventors have come to the conclusion that due to only using an ultraviolet absorbing agent having an absorption peak of less than 360 nm which is used in an ordinary protective film for polarizing plate, although the deterioration of polarizer in indoor use is effectively inhibited, it is still insufficient to inhibit the degradation of polarizer caused by sunlight in outdoor use, even when the addition amount thereof is increased to approximately several times the usual amount.

Specifically, any of the cellulose acylate films described in JP-A-2006-282979 and JP-A-2002-350644 is difficult to apply to a display device for outdoor use, for example, a digital signage, which is used outdoors for a long period of time.

Also, the film described in JP-A-2002-53824, JP-A-2002-80788, JP-A-2002-150827, JP-A-2003-112391, JP-A-2005-189645 and JP-A-2008-195830 has a problem in that although it has absorption in a wavelength range of 380 nm or more, because of including the fluorescent brightening agent the film per se emits blue light when exposed to a strong ultraviolet radiation in the outdoor, thereby causing significant reduction of the display quality.

The present invention has been made to solve the problems described above, and an object thereof is to provide a display device for outdoor use in which the deterioration of polarizer due to light is effectively inhibited even when exposed to sunlight in the outdoor for a long period of time and which has high display quality.

As a result of intensive investigations, the inventors have found that the degradation of polarizer due to sunlight in the outdoor use can be effectively inhibited without remarkably increasing the addition amount of light absorbing agent by using, in combination, at least two kinds of light absorbing agents comprising a first light absorbing agent having at least one absorption peak in a wavelength range from 280 to less than 360 nm and a second light absorbing agent having at least one absorption peak in a wavelength range from 360 to 400 nm.

Specifically, the problems described above can be solved by the means described below.

(1) A display device for outdoor use having a display unit, wherein the display unit has a polarizing plate comprising a light absorbing layer and a polarizer layer on a viewing side surface, the light absorbing layer contains a first light absorbing agent having at least one absorption peak in a wavelength range from 280 to less than 360 cm and a second light absorbing agent having at least one absorption peak in a wavelength range from 360 to 400 nm, and the light absorbing layer is disposed closer to the viewing side than the polarizer layer.
(2) The display device for outdoor use as described in (1) above, wherein the light absorbing layer comprises a first light absorbing layer containing the first light absorbing agent and a second light absorbing layer containing the second light absorbing agent.
(3) The display device for outdoor use as described in (1) or (2) above, wherein the light absorbing layer has light transmittance of 80% or more in a wavelength range from 430 to 650 nm.
(4) The display device for outdoor use as described in any one of (1) to (3) above, wherein the light absorbing layer is a film containing the first light absorbing agent and the second light absorbing agent in a base film containing a resin (the light absorbing layer is a base film containing a resin to which the first light absorbing agent and the second light absorbing agent are added).
(5) The display device for outdoor use as described in any one of (1) to (4) above, wherein the light absorbing layer comprises a layer formed by stacking on a base film a composition containing the first light absorbing agent and the second light absorbing agent.
(6) The display device for outdoor use as described in any one of (1) to (5) above, wherein the display unit comprises a liquid crystal cell, a light source, a polarizing plate disposed on a viewing side surface of the liquid crystal cell and a polarizing plate disposed on the light source side surface of the liquid crystal cell, the polarizing plate disposed on a viewing side surface of the liquid crystal cell is a polarizing plate having the light absorbing layer and the polarizer layer, and the polarizing plate disposed on the light source side surface of the liquid crystal cell comprises at least one protective film for polarizing plate having light transmittance of 50% or more at a wavelength of 400 nm.
(7) The display device for outdoor use as described in any one of (1) to (5) above, wherein the display unit is an organic electroluminescence display device.
(8) The display device for outdoor use as described in any one of (1) to (7) above, wherein the first light absorbing agent is any light absorbing agent selected from benzotriazole, triazine and benzophenone light absorbing agents, and the second light absorbing agent is any light absorbing agent selected from merocyanine, benzodithiol and benzoxazole light absorbing agents.
(9) The display device for outdoor use as described in any one of (4) to (8) above, wherein the light absorbing layer has a thickness of from 15 to 100 μm.
(10) The display device for outdoor use as described in any one of (1) to (9) above, wherein the light absorbing layer has light transmittance of less than 75% at a wavelength of 400 nm.
(11) The display device for outdoor use as described in any one of (1) to (10) above, wherein the light absorbing layer contains a cellulose acylate, and a total content of the first light absorbing agent and the second light absorbing agent is from 1 to 20 parts by weight based on 100 parts by weight of the cellulose acylate.
(12) The display device for outdoor use as described in any one of (2) to (10) above, which comprises a liquid crystal display device having the first light absorbing layer and a chassis having the second light absorbing layer.

According to the invention, a display device for outdoor use in which the deterioration of polarizer due to light is prevented even when exposed to sunlight in the outdoor for a long period of time or the like and which has high display quality can be provided.

### DETAILED DESCRIPTION OF THE INVENTION

The invention will be described in detail below. In the case where a numerical value represents a physical value, a characteristic value or the like, the expression “from (numerical value 1) to (numerical value 2)” or “(numerical value 1) to (numerical value 2)” as used herein means “from (numerical value 1) or more to (numerical value 2) or less”.

### <Display Unit>

The display device for outdoor use according to the invention has a display unit.

The display unit has a polarizing plate comprising a light absorbing layer and a polarizer layer on a viewing side surface.

In the display device for outdoor use according to the invention, the light absorbing layer is disposed closer to the viewing side than the polarizer layer.

The display unit is preferably a liquid crystal display device or an organic electroluminescence display device.

### [Light Absorbing Layer]

The light absorbing layer according to the invention is described below.

The light absorbing layer is not particularly restricted as far as it contains a first light absorbing agent having at least one absorption peak in a wavelength range from 280 to less than 360 nm and a second light absorbing agent having at least one absorption peak in a wavelength range from 360 to 400 nm.

Configuration of the light absorbing layer is not particularly restricted and it may be provided as two layers composed of a layer containing the first light absorbing agent and a layer containing the second light absorbing agent or as one layer containing both the first light absorbing agent and the second light absorbing agent. Further, the light absorbing layer may be disposed independently, may also have other function by adding the first light absorbing agent and/or the second light absorbing agent to other functional layer or base material to form the multiple functional layer or the base material having multiple functions, or may be a substrate separating a protective film for polarizing plate and a front plate for display device.

From the standpoint of simplification of manufacturing process or post-process, the light absorbing layer is a film containing the first light absorbing agent and the second light absorbing agent in a base film containing a resin. Also, in a case where it is difficult for the light absorbing agent to be contained in the resin in view of heat resistance of the light absorbing agent or compatibility with the resin, a layer containing the first light absorbing agent and the second light absorbing agent may be separately disposed on the base film, or in a case of film configuration, for example, a protective film for polarizing plate, a composition containing the light absorbing agent is coated to form a layer.

The base film on which the light absorbing layer is stacked or to which the light absorbing agent is added is not particularly restricted, and light transmittance of the base film in a wavelength range from 430 to 650 nm is preferably 80% or more, more preferably 85% or more, and most preferably 90% or more. It is preferred to have the high light transmittance because luminescence amount of a light source of liquid crystal display or a light-emitting element of organic EL display is able to be reduced so that the power consumption can be reduced and the heat generation of display device can be restrained to improve durability of the display device.

The base film for the light absorbing layer is preferably a resin (polymer) film, and includes, for instance, a film of cellulose acylate, for example, cellulose triacetate, cellulose diacetate, cellulose acetate butyrate or cellulose acetate propionate, a film of polyolefin, for example, polyethylene or polypropylene, a film of polyester resin, for example, polyethylene terephthalate or polyethylene naphthalate, a polyethersulfone film, a film of polyacrylic resin, for example, polymethyl methacrylate, a polyurethane resin film, a polyester film, a polycarbonate film, a polysulfone film, a polyether film, a polymethylpentene film, a polyether ketone film, a (meth)acrylonitrile film, a polyolefin film, a film of polymer having an alicyclic structure (norbornene resin (ARTON, produced by JSR Corp.), and a film of amorphous polyolefin (ZEONEX, produced by Zeon Corp.). Of the films, a cellulose triacetate film, a polyethylene terephthalate film and a film of polymer having an alicyclic structure, and a cellulose triacetate film is particularly preferred.

The base film may contain the light absorbing agent described above, a plasticizer, a retardation adjusting agent, a moisture and heat resistance improving agent or the like in order to impart various functions, in addition to the resin.

The plasticizer which can be used includes, for example, a phosphate ester plasticizer, a phthalate ester plasticizer, a polyhydric alcohol ester plasticizer, a multivalent carboxylate ester plasticizer, a glycolate ester plasticizer, a citrate ester plasticizer, a fatty ester plasticizer, a carboxylate ester plasticizer, a polyester oligomer plasticizer, a sugar ester plasticizer and an ethylenically unsaturated monomer copolymer plasticizer.

A thickness of the light absorbing layer is preferably from 15 to 100 μm, more preferably from 15 to 80 μm, and still more preferably from 15 to 40 μm. It is preferred that the thickness is 15 μm or more because the bleed out or whitening hardly occurs in case of adding the light absorbing agent. Also, it is preferred that the thickness is 100 μm or less because the display unit of display device for outdoor use can be made thin.

In order to effectively inhibit the deterioration of polarizer in the outdoor use, transmittance of the light absorbing layer at a wavelength of 400 nm is preferably less than 75%, more preferably less than 50%, and still more preferably less than 10%. The transmittance of the light absorbing layer at a wavelength of 400 nm can be adjusted by the kind and addition amount of the light absorbing agent.

The light absorbing layer may be the base film containing the light absorbing agent or may be a film stacked, for example, by coating a layer containing the light absorbing agent on the base film.

The film having the light absorption function or the film stacked with the light absorbing layer can be obtained according to a known method. For instance, the film can be produced with reference to descriptions, for example, in The Japan Institute of Invention and Innovation Technical Disclosure, KOGI No. 2001-1745, JP-A-2005-324461, JP-A-2006-232958, JP-A-2008-134389, WO 2007/119560, JP-A-2011-88430 and JP-A-2008-233882. Of the films, a cellulose acylate film containing the light absorbing agent is preferably used.

### [Light Absorbing Agent]

The light absorbing agent according to the invention comprises at least two light absorbing agents of a first light absorbing agent having at least one absorption peak in a wavelength range from 280 to less than 360 nm and a second light absorbing agent having at least one absorption peak in a wavelength range from 360 to 400 nm. The use of such a combination of the light absorbing agents is preferred because UVA, UVB and shortwave blue light, which are included in large amounts in sunlight and cause the deterioration of polarizer, can be effectively absorbed.

The material for the light absorbing agent according to the invention is not particularly restricted, and as the first light absorbing agent, a light absorbing agent selected from any of benzotriazole, triazine and benzophenone light absorbing agents is particularly preferably used. Specifically, light absorbing agents described, for example, in JP-A-11-71356, JP-A-2011-148865 and JP-A-2010-270336 can be referred to.

As the second light absorbing agent, a light absorbing agent selected from any of merocyanine, benzodithiol and benzoxazole light absorbing agents is preferably used. Specifically, light absorbing agents described, for example, in JP-A-2010-70478 and JP-T-2009-519993 can be referred to. The merocyanine and benzodithiol light absorbing agents are particularly preferably used because they have no fluorescent brightening function and hardly cause change in tint. Any of these light absorbing agents are preferred because they have the high light absorbing ability and reduction in the light absorbing ability is almost not recognized even when they are exposed to sunlight for a long period of time.

In the case where the protective film for polarizing plate doubles as the light absorbing layer according to the invention, the amount of the light absorbing agent contained in the film is preferably from 1 to 20 parts by weight, more preferably from 1 to 10 parts by weight, most preferably from 1 to 5 parts by weight, referred to 100 parts by weight of the polymer used in the base film. The amount of light absorbing agent of 20 parts by weight or less is preferred because the bleed out or whitening hardly occurs. On the other hand, the amount of light absorbing agent of 1 part by weight or more is preferred because the light absorbing ability necessary for protecting the polarizer from sunlight is easily exerted.

The amount of each of the first light absorbing agent and the second light absorbing agent is preferably from 0.5 to 10 parts by weight, more preferably from 1.0 to 2.5 parts by weight, referred to 100 parts by weight of the polymer used in the base film.

### [Polarizing Plate]

The display unit in the display device for outdoor use according to the invention has a polarizing plate (hereinafter, also referred to as a polarizing plate on viewing side) comprising a light absorbing layer and a polarizer layer on the viewing side surface.

The polarizing plate is preferably a stack made from at least a protective film and a polarizer layer (polarizer). As the polarizer, a stretched polyvinyl alcohol film dyed with polyiodine or a dichromatic dye is preferably used. It is also preferred to use the light absorbing layer described above as a protective film, and particularly preferred to use a cellulose acylate film containing the light absorbing agent.

The polarizing plate preferably has a protective film on a surface of the polarizer layer opposite to the light absorbing layer. As the protective film, a known protective film for polarizing plate can be used.

The polarizing plate may be a linear polarizing plate, a circularly polarizing plate or an ellipsoidal polarizing plate.

The polarizing plate may also be stacked with a retardation film. The retardation film can be preferably selected depending on the kind of display device (for example, VA type liquid crystal, IPS type liquid crystal, TN type liquid crystal or OLED).

### [Functional Layer]

Since the display device according to the invention is used in the outdoors, it is preferred that a function, for example, an anti-scratching property or an antireflective property is imparted on the display surface thereof, and the polarizing plate preferably has an embodiment where a functional layer, for example, a hardcoat layer or an antireflective layer is stacked on the outermost surface thereof. The antireflective layer is made from at least one layer designed in consideration of a refractive index, a layer thickness, a number of layers, an order of layers or the like so as to reduce the reflectance by optical interference. According to the simplest construction, the antireflective layer has a construction wherein only a low refractive index layer is provided on the outermost surface of a film. In order to further reduce the reflectance, the antireflective layer is preferably constructed by a combination of a high refractive index layer having a high refractive index and a low refractive index layer having a low refractive index. Examples of the construction include a two-layer construction having a high refractive index layer and a low refractive index layer in this order from the underside, and a construction of three layers having different refractive indexes wherein a middle refractive index layer (having a higher refractive index than a lower layer and a lower refractive index than a high refractive index layer), a high refractive index layer and a low refractive index layer are stacked in this order. Layer constructions wherein much more refractive index layers are stacked are also proposed. Among them, from the standpoint of durability, optical characteristics, cost, productivity or the like, a construction having on a hardcoat layer, a middle refractive index layer, a high refractive index layer and a low refractive index layer in this order is preferred, and constructions described, for example, in JP-A-8-122504, JP-A-8-110401, JP-A-10-300902, JP-A-2002-243906 and JP-A-2000-111706 are exemplified. Also, an antireflective film of three-layer construction excellent in robustness against variation in layer thickness is described in JP-A-2008-262187. In the case of disposing the antireflective film of three-layer construction on a surface of display device, an average value of reflectance can be controlled to 0.5% or less so that background reflections can be significantly reduced and images excellent in three dimensional appearance can be obtained. Further, other functions may be imparted to respective layers and, for example, a low refractive index layer having an antifouling property, a high refractive index layer having an antistatic property, a hardcoat layer having an antistatic property and a hardcoat layer having an antiglare property are exemplified (see, for example, JP-A-10-206603, JP-A-2002-243906 and JP-A-2007-264113).

### [Liquid Crystal Display Device]

As the display unit of the display device for outdoor use according to the invention, a liquid crystal display device comprising, for example, a liquid crystal cell, a light source, a polarizing plate disposed on a viewing side surface of the liquid crystal cell (viewing side polarizing plate) and a polarizing plate disposed on the light source side surface of the liquid crystal cell (light source side polarizing plate) (liquid crystal display device wherein the polarizing plate disposed on a viewing side surface of the liquid crystal cell is a polarizing plate having the light absorbing layer and the polarizer layer described above) is preferably used. Liquid crystal display devices of various display modes, for example, TN (Twisted Nematic), IPS (In-Plane Switching) or VA (Vertically aligned) are proposed. Also, display modes wherein the display modes described above are subjected to alignment division are proposed. The liquid crystal display device of any of the display modes described above may be used in the display device for outdoor use according to the invention. Of the modes, the liquid crystal display device of VA mode or IPS mode is particularly preferably used because it has a high display quality and is relatively easy to grown in size.

### [Light Source Side Polarizing Plate]

In the case where the display unit is a liquid crystal display device in the invention, as the polarizing plate (light source side polarizing plate) disposed on the light source side surface of the liquid crystal cell, a known polarizing plate can be used. It is preferably a polarizing plate comprising a polarizer layer and at least one protective film for polarizing plate, and light transmittance of the protective film for polarizing plate at a wavelength of 400 nm is preferably 50% or more, more preferably 70% or more, and most preferably 85% or more. It is preferred that the light transmittance at a wavelength of 400 nm is 50% or more because the yellowish coloration on the display hardly occurs and the transmittance hardly decreases.

### [Organic Electroluminescence Display Device]

As the display unit of the display device for outdoor use according to the invention, for example, an organic electroluminescence display device (organic EL display device) is preferably used. The organic EL display device is a display device in which a light-emitting layer or a plurality of organic compound thin layers including a light-emitting layer is formed between a pair of electrodes composed of an anode and a cathode, and may have a hole-injecting layer, a hole-transporting layer, an electron-injecting layer, an electron-transporting layer, a protective layer and the like in addition to the light-emitting layer. These layers each may have other function. Various materials may be used for forming each layer. An embodiment in which a circularly polarizing plate is stacked on the viewing side of the organic EL display device is preferred. Such an embodiment is preferred because the reflection of outside light including sunlight can be prevented and the display quality can be enhanced.

### [Display Device for Outdoor Use]

As to the display device for outdoor use according to the invention, the liquid crystal display device or organic EL display device described above as the display unit may be used as it is or the display unit may be used in a configuration in which the display unit is placed in a chassis. The configuration in which the display unit is placed in a chassis is preferred because failure of the display unit due to exposure to wind and rain in case of using outdoors can be prevented and further failure of the display unit due to high temperature caused by insolation can be prevented by providing an air conditioning system in the chassis.

In the case of providing the display device for outdoor use as a combination of the display device and the chassis, the light absorbing agent may be incorporated into the display unit of the chassis. For instance, according to an embodiment wherein the first light absorbing layer and the second light absorbing layer are provided on the display surface of the chassis or an embodiment wherein the display device having only the first light absorbing layer is placed in the chassis in which the second light absorbing layer is provided on the viewing surface, the effect of the invention can also be achieved.

The display device for outdoor use according to the invention can be provided a display device for outdoor use in which the deterioration of polarizer due to an ultraviolet ray is prevented even when exposed to sunlight in the outdoor for a long period of time and which has high display quality.

### EXAMPLES

The feature of the invention will be described more specifically with reference to the examples and comparative examples below. The materials, amounts of use, proportions, contents of treatments, treating procedures and the like described in the examples can be appropriately altered as long as the gist of the invention is not exceeded. Therefore, the scope of the invention should not be construed as being limited to the specific examples described below.

The cellulose acylate, light absorbing agent and plasticizer used in the examples are described below.

### (Cellulose Acylate)

A cellulose acylate having a substitution degree of acetyl group of 2.85 and a number average molecular weight of 66,000 was used. The cellulose acylate can be obtained according to a known synthesis method.

### (Plasticizer)

Triphenyl phosphate (TPP) was used in the examples and comparative examples. Triphenyl phosphate is available as a commercial product or can be obtained according to a known synthesis method.

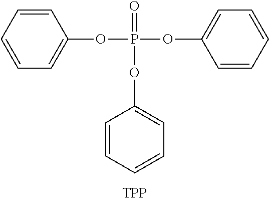

### (Light Absorbing Agent)

The light absorbing agents described below were used. These light absorbing agents are available as commercial products or can be obtained according to a known synthesis method.

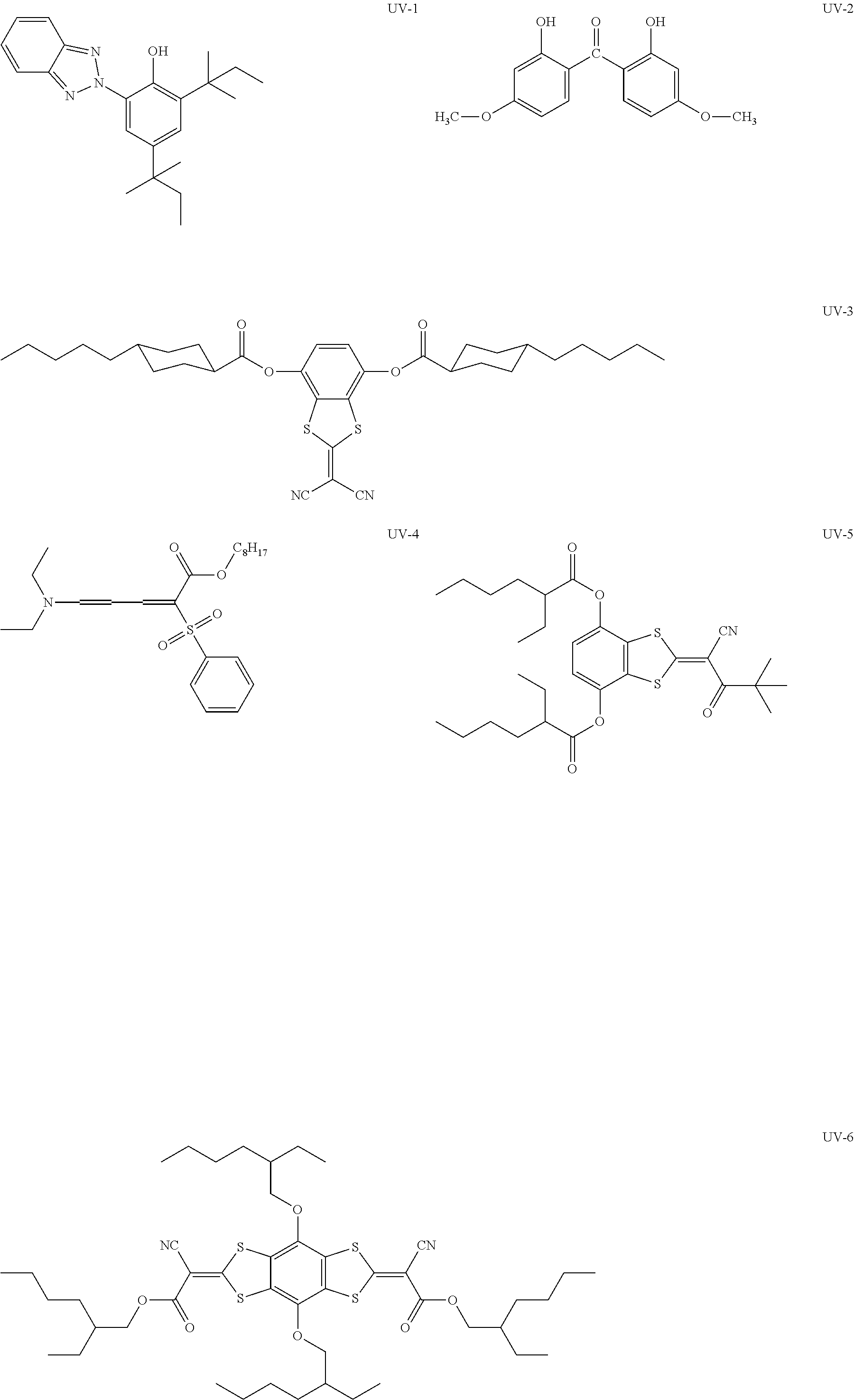

TABLE 1

| | UV-1 | UV-2 | UV-3 | UV-4 | UV-5 | UV-6 |
|---|---|---|---|---|---|---|
| Kind | Benzotriazole | Benzophenone | Benzodithiol | Merocyanine | Benzodithiol | Benzodithiol |
| Molecular | 351 | 274 | 609 | 422 | 560 | 873 |
| Weight | | | | | | |
| Typical | 344 nm | 354 nm | 366 nm | 372 nm | 376 nm | 386 nm |
| Absorption | | | | | | |
| Peak | | | | | | |
| Wavelength | | | | | | |

### (Production of Cellulose Acylate Film 101)

### (Preparation of Cellulose Acylate Dope 101)

The composition shown below was stirred with heating to dissolve the respective components to prepare Cellulose acylate dope 101.

(Composition of Cellulose acylate dope 101)

| | |
|---|---|
| Cellulose acylate (shown above) | 100 parts by weight |
| Plasticizer TPP (shown above) | 12 parts by weight |
| Methylene chloride | 435 parts by weight |
| Methanol | 65 parts by weight |
| Silica particle dispersion (average particle | 0.16 parts by weight |
| size: 16 nm) (AEROSIL R972, produced by Nippon | |
| Aerosil Co., Ltd.) | |
| Light absorbing agent UV-1 (shown above) | 1.6 parts by weight |
| Light absorbing agent UV-3 (shown above) | 2.1 parts by weight |

The solid content concentration (total concentration of the cellulose acylate, plasticizer, silica particle and light absorbing agent) of Cellulose acylate dope 101 was 19% by weight.

### (Film Formation of Cellulose Acylate Film 101)

Cellulose acylate dope 101 prepared according to the method described above was uniformly cast on a stainless steel band support. The solvent was evaporated on the stainless steel band support until the remaining solvent amount reached 30% by weight and the film was peeled from the stainless steel band support. A tension was applied during the peeling to stretch the film so as to have a stretching ratio of 1.02 times in the longitudinal direction (MD). Then, the film was dried in a drying zone at 140° C. for 40 minutes while being transported, and slit to a width of 1,500 mm to produce Cellulose acylate film 101 having a thickness of 60 μm.

### (Production of Cellulose Acylate Films 102 to 110)

Cellulose acylate films 102 to 110 were produced in the same manner as in Cellulose acylate film 101 except for changing the kind and amount of the light absorbing agent and thickness of the film as shown in Table 2 below, respectively.

TABLE 2

| | | | | | | | First Light | | | Second Light | | | | | |
|---|---|---|---|---|---|---|---|---|---|---|---|---|---|---|---|
| | | | | | | | Absorbing Agent | | | Absorbing Agent | | | | | |
| | Cellulose | | | Methylene | | Silica | | Typical | | | Typical | | | | |
| | Acylate | Plasticizer | | Chloride | Methanol | Particle | | Ab- | | | Ab- | | | Transmittance | |
| | Amount | | Amount | Amount | Amount | Amount | | sorption | | | sorption | | | of Film | |
| | (parts | | (parts | (parts | (parts | (parts | | Peak | Amount | | Peak | Amount | Thick- | | 430 to |
| | by | | by | by | by | by | | Wave- | by | | Wave- | (parts by | ness | 400 | 650 |
| | weight) | Kind | weight) | weight) | weight) | weight) | Kind | length | weight) | Kind | length | weight) | (μm) | nm | nm |
| 101 | 100 | TPP | 12 | 435 | 65 | 0.16 | UV-1 | 344 nm | 1.6 | UV-3 | 366 nm | 2.1 | 60 | 73% | ≧88% |
| 102 | 100 | TPP | 12 | 435 | 65 | 0.16 | UV-1 | 344 nm | 1.6 | UV-5 | 376 nm | 2.1 | 60 | 41% | ≧87% |
| 103 | 100 | TPP | 12 | 435 | 65 | 0.16 | UV-1 | 344 nm | 1.6 | UV-6 | 386 nm | 2.1 | 40 | 8% | ≧89% |
| 104 | 100 | TPP | 12 | 435 | 65 | 0.16 | UV-1 | 344 nm | 1.6 | UV-6 | 386 nm | 2.1 | 60 | 2% | ≧88% |
| 105 | 100 | TPP | 12 | 435 | 65 | 0.16 | UV-1 | 344 nm | 1.6 | UV-6 | 386 nm | 2.1 | 80 | 1% | ≧87% |
| 106 | 100 | TPP | 12 | 435 | 65 | 0.16 | UV-2 | 354 nm | 1.6 | UV-6 | 386 nm | 2.1 | 60 | 1% | ≧84% |
| 107 | 100 | TPP | 12 | 435 | 65 | 0.16 | UV-1 | 344 nm | 2.1 | None | — | — | 60 | 75% | ≧89% |
| 108 | 100 | TPP | 12 | 435 | 65 | 0.16 | UV-3 | 366 nm | 2.1 | None | — | — | 60 | 85% | ≧89% |
| 109 | 100 | TPP | 12 | 435 | 65 | 0.16 | UV-5 | 376 nm | 1.6 | UV-4 | 372 nm | 2.1 | 60 | 10% | ≧86% |
| 110 | 100 | TPP | 12 | 435 | 65 | 0.16 | None | — | — | None | — | — | 60 | 91% | ≧91% |

Cellulose acylate films 101 to 110 produced as described above were evaluated in the manner described below.

### (Measurement of Transmittance of Cellulose Acylate Films 101 to 110)

The light transmittance of the film was measured by a spectrophotometer (UV-3150, produced by Shimadzu Corp.) in a wavelength range from 400 to 650 nm at 25° C. and 60% RH. The light transmittances at a wavelength of 400 nm and in a wavelength range from 430 to 650 nm were described in Table 2 above.

### (Saponification Treatment of Cellulose Acylate Films 101 to 110)

Each of Cellulose acylate films 101 to 110 was immersed in an aqueous 2.3 mol/L sodium hydroxide solution at 55° C. for 3 minutes. The film was washed in a water washing bath tank at room temperature and neutralized at 30° C. using 0.05 mol/L of sulfuric acid. The film was again washed in a water washing bath tank at room temperature and dried by hot air of 100° C. Thus, the saponification treatment of the surface of each of Cellulose acylate films 101 to 110 was performed.

### (Production of Polarizer)

A polyvinyl alcohol (PVA) film having a thickness of 80 μm was immersed in an aqueous iodine solution having an iodine concentration of 0.05% by weight at 30° C. for 60 seconds to dye, stretched 5 times its original length while immersing in an aqueous boric acid solution having a boric acid concentration of 4% by weight for 60 seconds, and dried at 50° C. for 4 minutes, thereby producing a polarizer having a thickness of 19 μm.

### (Production of Polarizing Plates 201 to 210)

Any one of Cellulose acylate films 101 to 110 subjected to the saponification treatment was stuck on one surface of the polarizer and Cellulose acylate film 110 subjected to the saponification treatment was stuck on the other surface of the polarizer using a polyvinyl alcohol adhesive. The polarizer and cellulose acylate film were stuck so that the transmitting axis of the polarizer was parallel to the width direction of the cellulose acylate film. Thus, Polarizing plates 201 to 210 were produced.

Cellulose acylate films 101 to 106 are the light absorbing layer according to the invention and the polarizer is the polarizer layer.

TABLE 3

| Polarizing | Protective Film for Polarizing | Protective Film for Polarizing |
|---|---|---|
| Plate | Plate on One Surface | Plate on the Other Surface |
| 201 | Cellulose Acylate Film 101 | Cellulose Acylate Film 110 |
| 202 | Cellulose Acylate Film 102 | Cellulose Acylate Film 110 |
| 203 | Cellulose Acylate Film 103 | Cellulose Acylate Film 110 |
| 204 | Cellulose Acylate Film 104 | Cellulose Acylate Film 110 |
| 205 | Cellulose Acylate Film 105 | Cellulose Acylate Film 110 |
| 206 | Cellulose Acylate Film 106 | Cellulose Acylate Film 110 |
| 207 | Cellulose Acylate Film 107 | Cellulose Acylate Film 110 |
| 208 | Cellulose Acylate Film 108 | Cellulose Acylate Film 110 |
| 209 | Cellulose Acylate Film 109 | Cellulose Acylate Film 110 |
| 210 | Cellulose Acylate Film 110 | Cellulose Acylate Film 110 |

### Examples 1 to 7 and Comparative Examples 1 to 3

A liquid crystal panel of a smartphone (iPhone 4, produced by Apple Inc.) was took out, its polarizing plates on the viewing side and the light source side were removed, and then the polarizing plates on the viewing side and on the light source side were stuck according to the combination shown in Table 4 below. The polarizing plates were stuck so that the surface of Cellulose acylate film 110 was brought into contact with a glass substrate of the liquid crystal panel and so that the transmitting axis of the polarizer on the viewing side was perpendicular to the transmitting axis of the polarizer on the light source side. The resulting liquid crystal panel was again installed into a chassis of the iPhone 4, thereby producing display devices for outdoor use for Examples 1 to 7 and Comparative Examples 1 to 3, respectively.

The display devices for outdoor use for Examples 1 to 7 and Comparative Examples 1 to 3 produced as described above were evaluated in the manner described below.

### (Evaluation of Tinting)

Each of the display devices for outdoor use for Examples 1 to 7 and Comparative Examples 1 to 3 was southward placed outdoors (in Minami-Ashigara City, Kanagawa Prefecture, Japan) at noon of a clear day and observed from the front side while displaying various still images. The tinting of the display was evaluated according to the criteria shown below.

A: The tinting was not visually observed at all.
B: Although the tinting was visually observed, it was very slight and acceptable.
C: The tinting was visually observed and unacceptable.

### (Evaluation of Light Fastness)

### (Contrast Measurement Before Light Fastness Test)

Each of the display devices for outdoor use for Examples 1 to 7 and Comparative Examples 1 to 3 was switched to the overall white display, and luminance Y “white” was measured using a luminance meter (BM-5A, produced by Topcon Technohouse Corp.). Then, it was switched to the overall black display, and luminance Y “black” was measured in the same manner as above. A contrast CR of the display device for outdoor use was determined using Formula 1 described below.

CR=Y “black”/Y “white” Formula 1

### (Carrying Out of Light Fastness Test)

Each of the display devices for outdoor use for Examples 1 to 7 and Comparative Examples 1 to 3 was placed in Super Xenon Weather Meter SX75 produced by Suga Test Instruments Co., Ltd. so that the viewing side was exposed to light and exposed to light for 400 hours under the circumstances of 60° C. and 50% relative humidity. The light irradiated from the Super Xenon Weather Meter SX75 has a spectra similar to sunlight and the light fastness test which simulates outdoor use can be carried out.

The contrast of each of the display devices for outdoor use for Examples 1 to 7 and Comparative Examples 1 to 3 after the irradiation by the Super Xenon Weather Meter SX75 was measured in the same manner as above, and an amount of change in the contrast between before and after the irradiation by the Super Xenon Weather Meter SX75 was determined and evaluated according to the criteria shown below.

A: The change in the contrast was less than 5%.
B: The change in the contrast was from 5 to less than 10%.
C: The change in the contrast was 10% or more.

The constitution and evaluation results of the display device for outdoor use are shown in Table 4 below.

TABLE 4

| | | | | Change in Contrast between |
|---|---|---|---|---|
| | | | | Before and After Irradiation by |
| | Polarizing Plate on | Polarizing Plate on | | Super Xenon Weather Meter |
| | Viewing Side | Light Source Side | Tinting | SX75 for 400 Hours |
| Example 1 | Polarizing Plate 201 | Polarizing Plate 210 | A | B |
| Example 2 | Polarizing Plate 202 | Polarizing Plate 210 | A | A |
| Example 3 | Polarizing Plate 203 | Polarizing Plate 210 | A | B |
| Example 4 | Polarizing Plate 204 | Polarizing Plate 210 | A | A |
| Example 5 | Polarizing Plate 205 | Polarizing Plate 210 | A | A |
| Example 6 | Polarizing Plate 206 | Polarizing Plate 210 | B | A |
| Example 7 | Polarizing Plate 206 | Polarizing Plate 202 | C | A |
| Comparative | Polarizing Plate 207 | Polarizing Plate 207 | A | C |
| Example 1 | | | | |
| Comparative | Polarizing Plate 208 | Polarizing Plate 207 | A | C |
| Example 2 | | | | |
| Comparative | Polarizing Plate 209 | Polarizing Plate 207 | C | C |
| Example 3 | | | | |

From the results shown above, it can be seen that the display device for outdoor use according to the invention can effectively inhibit the contrast change of polarizer due to an ultraviolet ray even when exposed to sunlight in the outdoor for a long period of time and thus, the deterioration of display quality between before and after exposure to sunlight is small.

What is claimed is:

1. A display device for outdoor use comprising a display unit, wherein the display unit comprises a polarizing plate comprising a light absorbing layer and a polarizer layer on a viewing side surface, the light absorbing layer comprises a first light absorbing agent having at least one absorption peak in a wavelength range of from 280 to less than 360 nm and a second light absorbing agent having at least one absorption peak in a wavelength range of from 360 to 400 nm, and the light absorbing layer is disposed closer to the viewing side than the polarizer layer.

2. The display device for outdoor use as claimed in claim 1, wherein the light absorbing layer comprises a first light absorbing layer containing the first light absorbing agent and a second light absorbing layer containing the second light absorbing agent.

3. The display device for outdoor use as claimed in claim 1, wherein the light absorbing layer has light transmittance of 80% or more in a wavelength range of from 430 to 650 nm.

4. The display device for outdoor use as claimed in claim 1, wherein the light absorbing layer is a base film containing a resin to which the first light absorbing agent and the second light absorbing agent are added.

5. The display device for outdoor use as claimed in claim 1, wherein the light absorbing layer comprises a layer formed by stacking on a base film a composition containing the first light absorbing agent and the second light absorbing agent.

6. The display device for outdoor use as claimed in claim 1, wherein the display unit comprises a liquid crystal cell, a light source, a polarizing plate disposed on a viewing side surface of the liquid crystal cell and a polarizing plate disposed on the light source side surface of the liquid crystal cell, the polarizing plate disposed on a viewing side surface of the liquid crystal cell is a polarizing plate comprising the light absorbing layer and the polarizer layer, and the polarizing plate disposed on the light source side surface of the liquid crystal cell comprises at least one protective film for polarizing plate having light transmittance of 50% or more at a wavelength of 400 nm.

7. The display device for outdoor use as claimed in claim 1, wherein the display unit is an organic electroluminescence display device.

8. The display device for outdoor use as claimed in claim 1, wherein the first light absorbing agent is a light absorbing agent selected from benzotriazole, triazine and benzophenone light absorbing agents, and the second light absorbing agent is a light absorbing agent selected from merocyanine, benzodithiol and benzoxazole light absorbing agents.

9. The display device for outdoor use as claimed in claim 4, wherein the light absorbing layer has a thickness of from 15 to 100 μm.

10. The display device for outdoor use as claimed in claim 1, wherein the light absorbing layer has light transmittance of less than 75% at a wavelength of 400 nm.

11. The display device for outdoor use as claimed in claim 1, wherein the light absorbing layer contains a cellulose acylate, and a total content of the first light absorbing agent and the second light absorbing agent is from 1 to 20 parts by weight based on 100 parts by weight of the cellulose acylate.

12. The display device for outdoor use as claimed in claim 2, which comprises a liquid crystal display device having the first light absorbing layer and a chassis having the second light absorbing layer.
